(19) United States
(12) Patent Application Publication
(10) Pub. No.: US 2014/0029046 A1
(43) Pub. Date: Jan. 30, 2014

(54) METHOD AND SYSTEM FOR AUTOMATICALLY CHECKING COMPLETENESS AND CORRECTNESS OF APPLICATION FORMS

(71) Applicants: Kovendhan Ponnavaikko, Chennai (IN); Rinku Gajera, Bangalore (IN); Nischal M. Piratla, Hyderabad (IN); Jegan Joseph, Chennai (IN); Sivasubramanian Kandaswamy, Chennai (IN); Anoop Surendran, Thrissur (IN)

(72) Inventors: Kovendhan Ponnavaikko, Chennai (IN); Rinku Gajera, Bangalore (IN); Nischal M. Piratla, Hyderabad (IN); Jegan Joseph, Chennai (IN); Sivasubramanian Kandaswamy, Chennai (IN); Anoop Surendran, Thrissur (IN)

(73) Assignee: XEROX CORPORATION, Norwalk, CT (US)

(21) Appl. No.: 13/559,630

(22) Filed: Jul. 27, 2012

(51) Int. Cl. G06Q 10/00; G06K 15/00

(52) U.S. Cl. 358/1.15; 705/342

(57) ABSTRACT

The present disclosure discloses a system for automatically checking completeness and correctness of application forms and that system includes a device, and a user interface. The device is configured to receive a filled out application form for scanning, and identify a type of application form corresponding to the scanned form; the application form includes various fields. The device is configured to retrieve a configuration file corresponding to the form type, the configuration file including threshold values and rules. The device then extracts filled out content and finally utilizes the configuration file to determine at least one of the completeness and correctness of the forms. Further, the user interface is configured to display one or more messages to a customer, based on the threshold values and rules. Finally, the user interface is configured to allow the customer to perform one or more actions based on the one or more messages.

### CROSS-REFERENCE TO RELATED APPLICATION(S)

The present disclosure relates to U.S. application Ser. No. 13/359,510, filed Jan. 27, 2012, which is incorporated herein in its entirety by this reference.

### TECHNICAL FIELD

Broadly, the presently disclosed embodiments relate to application forms for various business services, more particularly, to methods and systems for automatically checking completeness and correctness of application forms.

### BACKGROUND

Business services, such as banking, telecom or postal play a significant role in the day-to-day life of individuals. To access any of the services, customers must fill out one or more application forms, which generally vary based on the service. For example, if a customer wishes to open a new account with a bank, she has to fill out an account opening form, but if the customer wants to apply for a loan, he or she has to fill out the corresponding loan application form. As a current practice, the customer fills-out an application form at a bank branch and submits the filled form to a bank representative. The branch representative then manually checks the application forms to verify whether the application form is completely filled out or not. The representative also checks for correctness of the application form. Based on this document review, the customer may be required to correct errors or provide additional information to correctly fill out the form. The branch representative again checks the application form, more specifically, for corrected entries. After this, the application form is couriered to a central location or back-office for further checking and processing. At the back-office, the forms are checked again for complete supporting documents—PAN (Personal Account Number), Driver's License, or the like. In case of missing information, the filled out forms are sent back to the customer. This process goes on until the application form is completed appropriately along with the supporting documents.

The existing approach requires a significant manual effort, and thus, unnecessarily increases the processing time. Particularly for rural areas, the processing time can run into weeks or months, making the current technique inefficient. Moreover, a significant cost, both in terms of time and resources, is spent on checking forms filled out at the customer end and at the back-office. Therefore, there is a strong need to improve the existing approach.

### SUMMARY

The present disclosure discloses a system for automatically checking completeness and correctness of application forms and that system includes a device, and a user interface. The device is configured to receive a filled out application form for scanning, and identify a type of application form corresponding to the scanned form; the application form includes various fields. The device is further configured to retrieve a configuration file corresponding to the form type, the configuration file including threshold values and rules. The device then extracts filled-out content and finally utilizes the configuration file to determine at least one of the completeness and correctness of the forms. Further, the user interface is configured to display one or more messages to a customer, based on the threshold values and rules. Finally, the user interface is configured to allow the customer to perform one or more actions based on the one or more messages.

Embodiments of the disclosure discloses a system for automatically checking completeness or correctness of a filled out application form. The system includes a scanner device configured to receive a filled out application form for scanning, the application form including various fields. The system further includes a network interface configured to connect the scanner device to a network. Further, the system includes a server configured to communicate with the scanner device to perform the following. The server receives the scanned copy of the filled out application form through the network interface. The server then identifies a type of the application form; and based on the form type, the server retrieves a configuration file including one or more threshold values and rules. Thereafter, the server extracts content filled into the fields in the application form, and utilizes the configuration file to determine at least one of the completeness and correctness of the application form. Additionally, the system includes a user interface configured to display one or more messages to a customer based on the threshold values and rules in the configuration file, and allow the customer to correct the filled out application form based on the one or more messages.

Other embodiments disclose a system configured to check completeness or correctness of filled out application forms. The system discloses a device that includes a scanner configured to scan a filled out application form. The device further includes an application running on the device and further configured to identify a form type of the filled out application form, the application form including various fields. The application is configured to retrieve a configuration file corresponding to the form type, the configuration file including one or more threshold values and rules. The application is further configured to extract content filled into the fields in the application form, and utilize the configuration file to determine at least one of the completeness and correctness of the application form. The system above further includes a user interface in communication with the application. The user interface is further configured to display one or more messages to a customer, based on the threshold values and rules in the configuration file, and allow the customer to perform one or more actions based on the one or more messages.

Further embodiments disclose a method for automatically checking completeness and correctness of filled out application forms. The method includes providing a device configured to identify a type of application form filled out by a customer, the application form including various fields. The device is configured to retrieve a configuration file corresponding to the type of application form, the configuration file being associated with one or more threshold values and rules and is configured to extract content filled into the fields in the application form. The device is further configured to utilize the configuration file to determine at least one of the completeness and correctness of the filled out application form. The method further includes interfacing with the customer to perform one or more functions including displaying one or more messages to the customer based on the threshold values and rules in the configuration file, and allowing the customer to perform one or more actions based on the displayed messages.

Additional embodiments disclose a method for automatically checking completeness and correctness of filled out application forms. The method includes providing a device configured to identify a type of application form filled out by a customer, the application form including various fields, and retrieve a configuration file corresponding to the form type, the configuration file including one or more threshold values and rules. The device is further configured to extract content filled into the fields in the application form, and calculate an average intensity of pixels of each field. For each field, the calculated intensity is compared with a corresponding threshold value in the configuration file to determine completeness of the application form. The method includes applying one or more rules to determine at least one of the completeness and correctness of the filled out application form. Moreover, the method includes interfacing with the customer to perform one or more functions. The functions include displaying one or more messages to the customer, based on the comparison and the rules applied, and enabling the customer to perform one or more actions based on the displayed messages.

### BRIEF DESCRIPTION OF THE DRAWINGS

FIG. 1 illustrates an exemplary embodiment for checking correctness and completeness of application forms, according to the disclosure.

FIGS. 2A-2B, 2C, and 2D are snapshots of an original application form, a filled out form, and extracted filled out content, respectively according to one embodiment of the disclosure.

FIG. 3 is an exemplary configuration file.

FIG. 4 is an exemplary flowchart for checking correctness and completeness of application form.

FIG. 5A is an exemplary snapshot of error messages and FIG. 5B is a dialog box showing errors corrected by the customer.

FIG. 6 shows a block diagram for checking completeness and correctness of forms.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Definitions

In various embodiments of the present disclosure, definitions of one or more terms that will be used in the document are described below. The disclosure includes a device that facilitates the automation of various types of operations that are generally performed in a business center, such as bank branch, telecom center, postal office, or the like. For ease of reference, this device will be referred to as an “automation system” since it serves to automate the process of checking completeness and correctness of an application form. As is discussed in greater detail below, the automation system performs checking and verification by executing a number of steps, including the scanning of the filled out document, extraction of the filled out content and analysis of content fields. Typically, the automation system has a capability for receiving a document, and a display or print feature for displaying an output. Additionally, the automation system may include the functionality of printing, faxing, and copying.

It is envisioned that the automation system can participate in a network with a number of other devices and entities. For purposes of this application, a “headquarter device” will refer to a device at a higher organizational level than the automation system, while a “peer device” will refer to a device at the same general organizational level as the automation system. “Support systems” or “back-office systems” refer to systems that perform support and services, such as data entry, verifying documents, or processing transactions, or the like.

### Overview

Broadly, the disclosure relates to handling application forms corresponding to various business services such as, banking, telecom, or postal services. For each of the business services, there are different application forms. For example, banking services have forms relating to opening a new account, changing personal information, applying for a loan and so forth. The application forms for telecom services may include buying a new connection and so on. The primary aim of the disclosure is to automate the process of checking completeness and/or correctness of the information filled out on the application forms at the customer end. To this end, an automation system is provided at the customer end. More particularly, the automation system utilizes a configuration file to determine the completeness or correctness of application forms. The configuration file includes one or more rules and threshold values. Based on the threshold values and the rules, the automation system checks for completeness or correctness and displays one or more error messages accordingly. The errors can be corrected by the customer through the automation system. Alternatively, the customer can choose to ignore the errors.

### Exemplary Embodiment

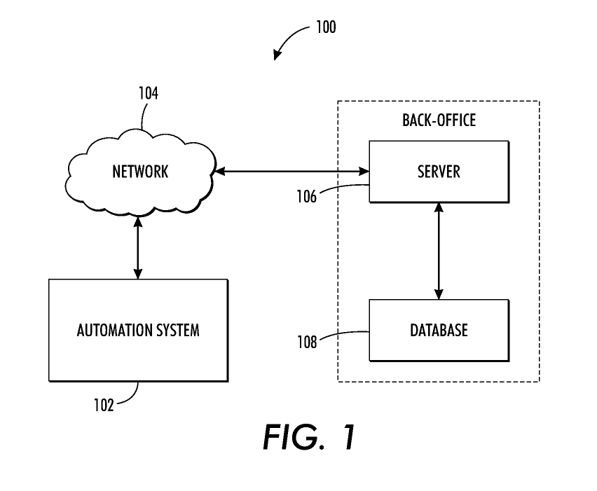

FIG. 1 illustrates an overall exemplary system 100 of the disclosure. The system 100 includes an automation system 102 (which will be hereinafter referred to as a system 102), a network 104, a server 106, and a database 108. The shown components communicate with each other via conventional network protocols. The server 106 and database 108 collectively, form part of a back-office. In one embodiment, the functionalities of the database 108 may be integrated with the server 106 and thus, a single unit can be defined. Each of these system components will be described in detail in the following sections.

The system 102 may perform a number of operations that are performed in a business center or bank branch. For example, the system 102 may perform functions related to sending or receiving filled out application forms, scanning forms, printing and copying. As part of the functionality defined in the present application, the system 102 checks the correctness and/or completeness of filled out application forms by scanning the forms, extracting the filled out content and evaluating the content based on threshold values. In one embodiment, the system 102 uses a configuration file that includes one or more rules and threshold values, based on which the automation system 102 determines the completeness or correctness of the forms. After analyzing the filled out content fields, the system 102 may generate one or more error messages. The error messages indicate fields that are not filled out correctly, for example, the “Pin Code” field. The system 102 also displays which of the fields are incomplete, for example, the “residential details”. In some embodiments, the system 102 matches the filled out content, such as “full name”, with details in the supporting documents, for example, the PAN card to determine the correctness or completeness of the forms. If the details do not match, the system 102 generates an error message, for example, indicating that the field—“full name”, is filled out wrongly, and accordingly displays an error message.

In this embodiment, the customer is given the option to decide which errors to fix and which to ignore. The corresponding actions taken by the customer are logged along with the error messages. The error messages and the actions are maintained in a log file. The customer is then required to make the corresponding changes on the hard copy of the application form and re-scan the document for follow-up error checking Once the error checking process is complete, the system 102, in this embodiment, sends the log file and the extracted filled out content over the network 104.

In addition to the above, the system 102 may allow the customer to perform additional activities including paying bills, viewing account summary, printing statements, printing reports, viewing branch reports, uploading documents, downloading documents, and so on, however these extraneous functions are not related to the system and method of the present disclosure.

In various embodiments, the system 102 can be a combination of a scanner, which may form part of a multi-function device, and a user interface; the user interface may or may not be a part of the multi-function device. In such embodiments, the multi-function device is configured to perform the correctness or completeness check along with the functionalities of printing, scanning or copying, and the user interface is configured to display various messages or allow the customer to correct the filled out application forms. In the primary embodiment, the system can be a combination of a multi-function device, a network interface, a server and a user interface. In such implementations, the multi-function device simply performs the functionalities of printing, scanning, or copying. The multi-function device further receives input from the customer in the form of the filled out form for scanning Further, the network interface connects the multi-function device over the network, which may be Local Area network, Wide Area Network, or the like. For example, the network interface connects the multi-function device to the server. The server here is configured to receive an input from the multi-function device. The input may be the scanned copy of the filled out application form and based on that input, the server performs the completeness or correctness check of the application forms and generates the error messages. These error messages are sent as a log to the multi-function device. The multi-function device then displays the error messages to the customer through the user interface. The user interface may be a part of the multi-function device or may form a part of the external system or remote system. Based on the error messages, the customer can correct fields. The form can be corrected either on the multi-function device or on the hard copy of the form. In the latter case, the multi-function device scans the corrected form again and sends that to the server for follow-up error checking and this process keep on repeating till the application form is filled out appropriately or correctly.

For the sake of simplicity, the disclosure is described with the help of the system 102, but it must be noted that the system 102 can be a combination of one or more entities including multi-function device, user interface, server, network interface, database, various modules, or the like.

As shown in FIG. 1, the network 104 is typically used to connect the system 102 to the back-office, such as a central main bank branch. According to one embodiment of the present disclosure, network 104 may be wired or wireless. Network 104 may be implemented as one or more of conventional wired or wireless networks. Various examples of such networks include, but not limited to, Local Area Network (LAN), Wide Area Network (WAN), a Metropolitan Area Network (MAN), Wireless LAN, and so forth. Additionally, network 104 can be a local, regional, or global communication network such as an enterprise telecommunication network, the Internet, a global mobile communication network, or any combination of similar systems.

At the back-office, the server 106 receives the extracted filled out content along with the log file and subsequently saves the received information in the database 108. In the back-office, verification of the forms or data entry related activities are performed. The received log file may be utilized for verifying forms in the back-office.

### Exemplary Application Forms

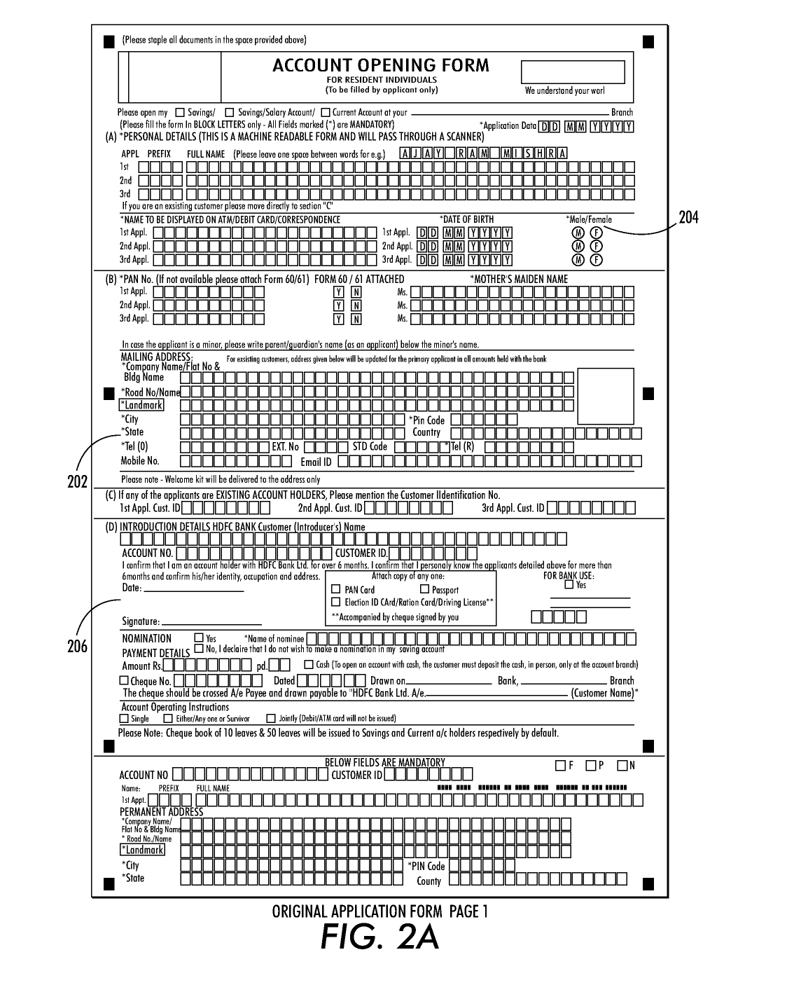

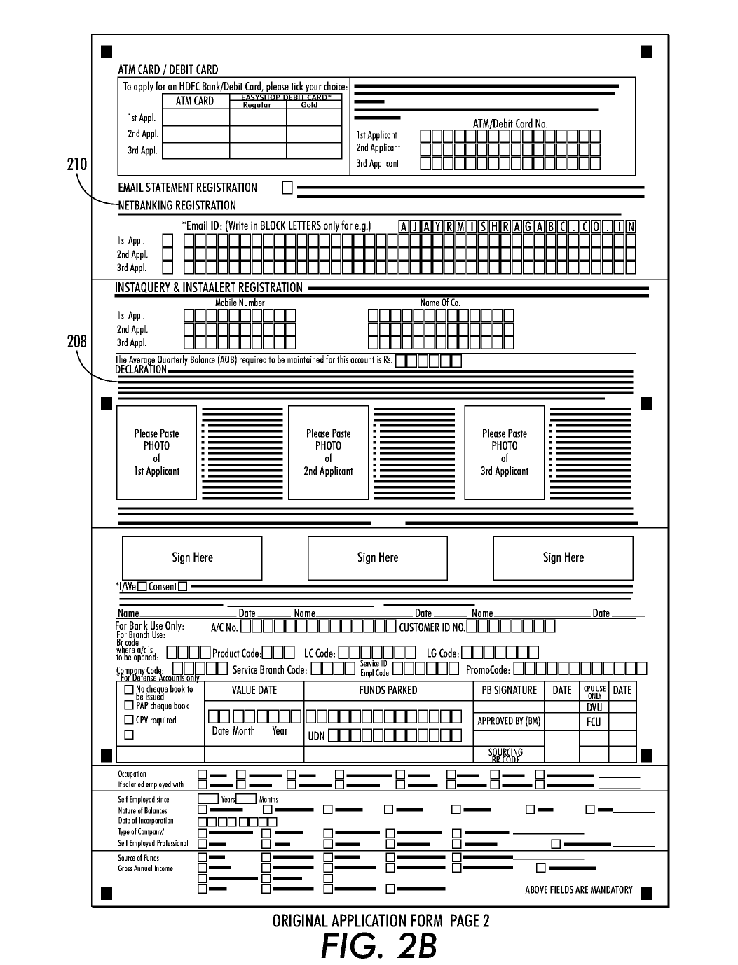

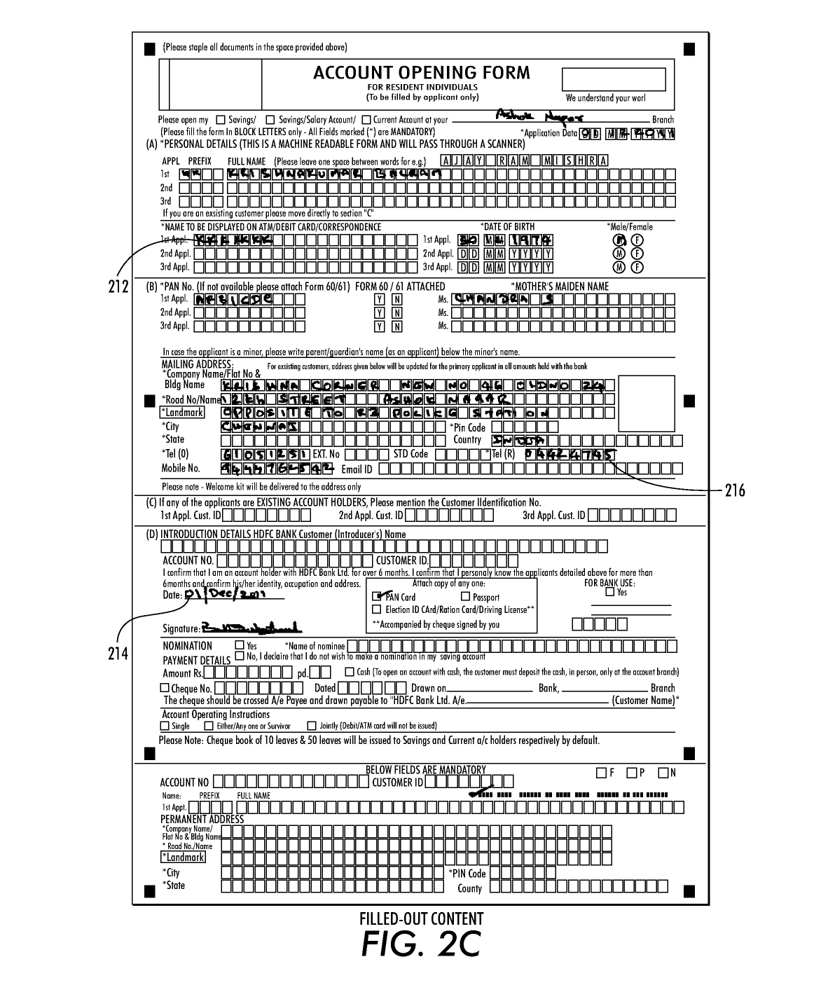

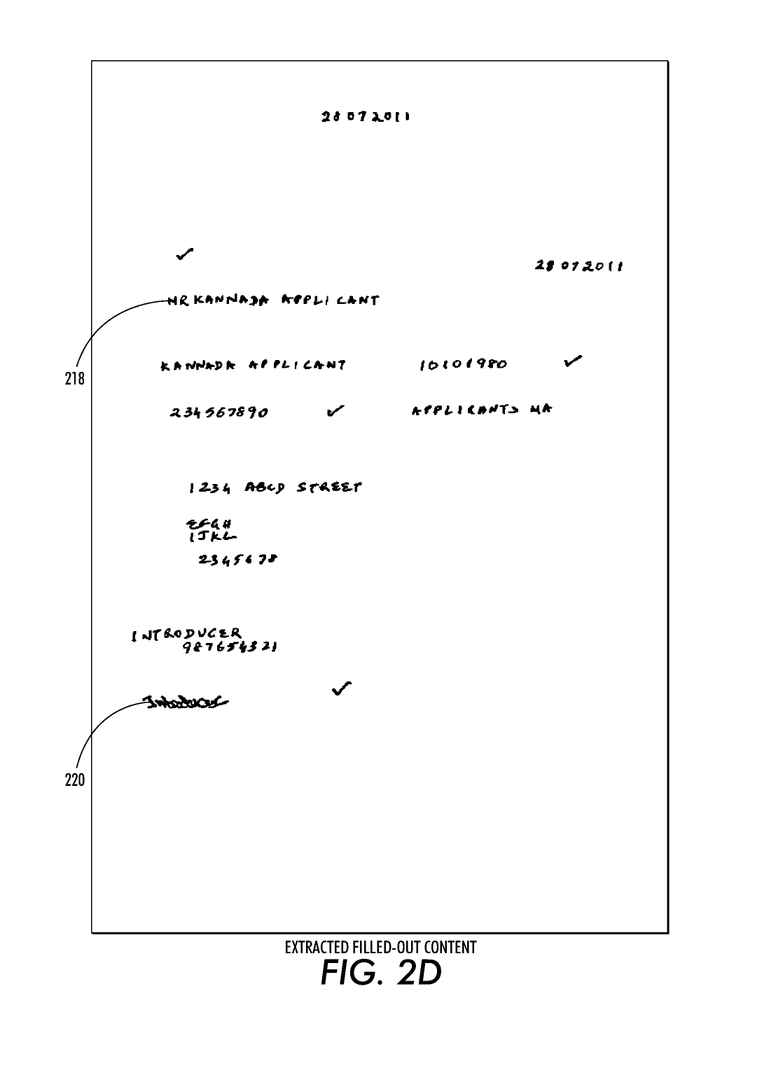

FIGS. 2A-2B show a 2-page original, blank application form. In general, the application form includes various fields, such as, first name, last name, age, permanent address, date of birth, contact number, or email id. Some of the fields such as, “state”, “male/female”, “date”, “net banking registration”, “declaration” are marked as 202, 204, 206, 210, and 208, respectively in FIGS. 2A-2B. These fields constitute background information relating to the customer and copies of these forms are stored in the back-office. A form filled out by a customer is shown in FIG. 2C and some of the filled out fields are shown as 212, 214, and 216—Name, Date, Telephone, respectively.

Referring to FIG. 2D, the filled out content is extracted by the system 102, as is shown, for example, by the content items 218 and 220. It must be noted that the blank application form, filled out application form, and extracted content are just exemplary in nature and thus, do not limit the scope of the disclosure in any way.

### Exemplary Configuration File

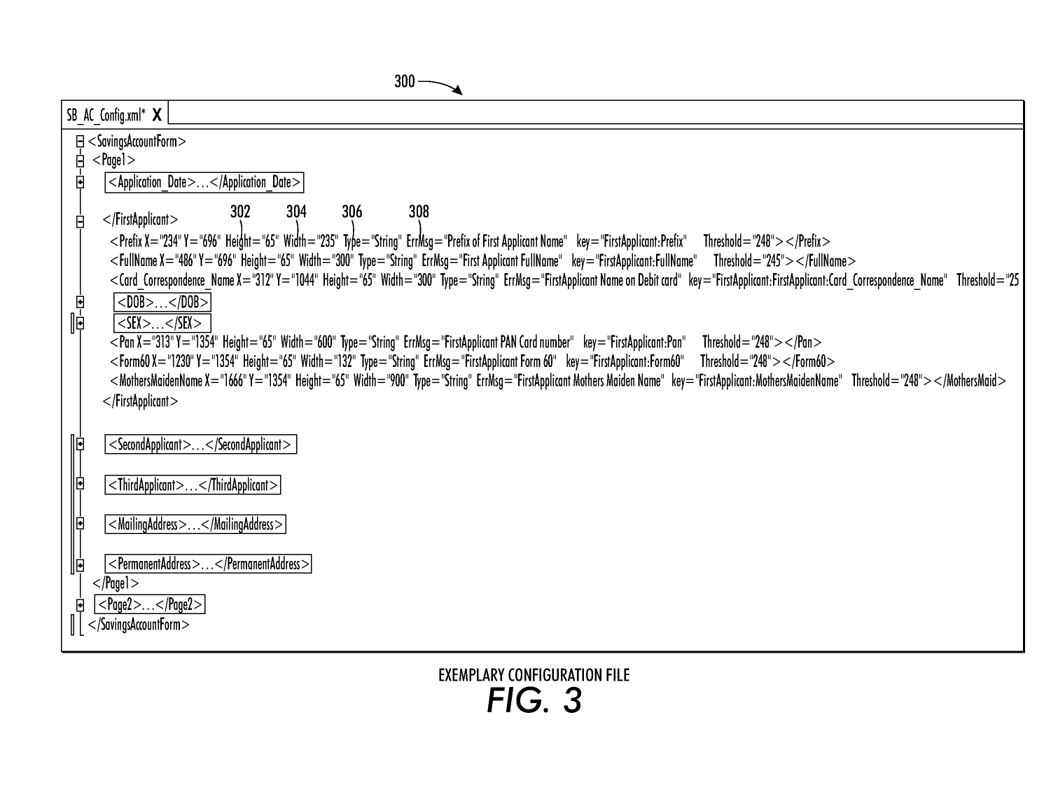

For each application form, a corresponding configuration file is pre-defined in any known format. XML (EXtensible Markup Language) is adopted in this embodiment. The configuration file is a metadata file that stores all fields of the form and related attributes such as name, number of characters allowed for the field and so on. Given a new form, information about different input fields is extracted and stored in the form of an XML document. One such exemplary file 300 is shown in FIG. 3. The configuration file 300 includes various attributes, threshold values, or rules. For each field in the form, a pre-defined representation is defined and maintained. For example, the “first applicant” field in the form may be denoted by <FullName> within the <FirstApplicant> tag in the configuration file 300. The <FirstApplicant> tag may further have child tags pertaining to “Date of Birth”, “Gender”, “PAN” or the like. The child tags denote the details related to the first applicant.

In one example, the attributes may include, but are not limited to, “X”, “Y”, “height”, “width”, “type”, “errmsg”, “key”, and “threshold”. Some of these attributes—“height”, “width”, “type”, “errmsg” are marked as 302, 304, 306, and 308 respectively. Herein, “X”, “Y” are the starting and ending positions of a field in the unfilled form. The attributes “height” and “width” represent the height and width values of the particular field in the unfilled form. The “type” attribute defines the data type of the field. For example, the field “fullname” is a string type, while the field “phone number” is a number data type. Moreover, the field “address” may be alphanumeric. “Errmsg” refers to an error message to be displayed in case of incorrect or incomplete entry against any field in the form. The error message may be prompted in case of any validation error captured while processing the filled out application form. “Key” here represents a unique identity for the definition tag. Additionally, the “threshold” is the average pixel intensity for a particular field and is used as one of the criteria to determine the completeness check of the content. The “threshold” values may range from 0 to 255; the value 0 here represents all black pixels fields, while 255 indicates all white pixels fields. Alternatively, the value 0 may denote all white pixels and 255 may represent all black pixels. In the present embodiment, the threshold 245, for example, means that at least 4% of the box must have black pixels for the field to be considered filled. If the number is higher than 245, then the number of white pixels exceeds the threshold and the field is considered not to be filled out. Other attributes may be whether the field is mandatory or not.

Further, the configuration file 300 includes one or more rules to determine the correctness of the field in the form. In one example, the rule may be that the check boxes for married or unmarried cannot both be filled out. The configuration file 300 also stores relationship data between different fields. An example for a relationship between fields is that, if a ‘Second Applicant Name’ has been provided, details associated with the second applicant, such as ‘Second Application Address’, ‘PAN Card Number’, etc. must also be provided.

The configuration file 300 varies with the type of form. For example, the configuration file 300 for “Savings Account form” may be different from the configuration file 300 for the “Loan Application form”, accordingly, the attributes or threshold values may differ. The configuration file 300 may thus be customized as per the requirements.

### Exemplary Flowchart

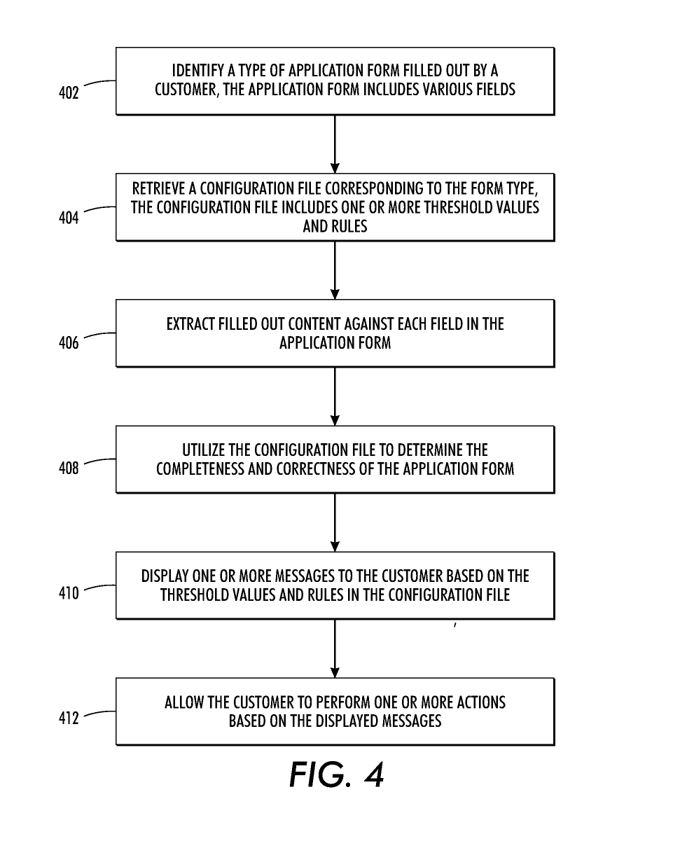

FIG. 4 is a method flowchart for automatically checking completeness or correctness of application forms, in particular, hand-filled application forms. It must be noted that the flowchart will be discussed in the context of front-end and back-end. At the front-end, a system 102 is provided that allows the customer to fill out an application form by hand, scan the form for error checking, acknowledge each error and possibly re-scanning the corrected form, while at the back-end, a server 106 is maintained to receive the content sent from the automation system 102 and proceed accordingly. In this embodiment, the system 102 at the customer end is a combination of a multi-function device, a server, a network interface, a user interface, and a database. As discussed, above, the multi-function device is mainly responsible for scanning or printing purposes, while the server performs the completeness or correctness check. The user interface is used to display outputs to the customer. In other embodiments, the system 102 may include a multi-function device and a user interface. Here, the multi-function device performs the completeness and correctness check on the forms, whereas the user interface allows the customer to interact with the system, for example, the user interface displays messages to the customer and further allows the customer to take the necessary actions based on the messages. The customer can ignore the errors or fix the errors. Once corrected, the multi-function device handles the corrected form.

In many implementations, the system 102 may include a software program or an application configured to perform completeness or correctness check of application forms. To this end, the system 102 may include various modules. Alternatively, the modules may be present within the system or external to the system 102. For instance, some of the modules may be present within the system 102, while the rest may be available over the network. In this case the system 102 calls the modules when needed.

### At the Automation System

Initially, a customer logs into the system 102 and chooses one option amongst various displayed options. For example, it can be considered that the customer chooses an option “Opening an Account” of type “Savings”. The customer is now required to fill out the application form. The application form is filled out by hand. After completing the form, the customer scans the form through the system 102. While scanning the form, at 402, the system 102 identifies the form type, for example, a form of type Savings Account, or Corporate Account. The form type may also be identified through the form id, or form number.

At 404, a configuration file corresponding to the identified form type is retrieved. The configuration file 300 includes certain threshold values, rules, or the like. Thereafter, at 406, content filled into each field is extracted. Here, the extraction includes removing background from the filled out content of the application form. To extract the content, various match-lifting and annotation algorithms can be applied as are known in the art. Such algorithms extract the difference between the filled out form and the original unfilled form. At 408, the retrieved configuration file 300 is utilized to determine the completeness or correctness of the form. To elaborate, the automation system 102 calculates the average intensity of content filled into each field in the form. Then, the calculated value is compared against the corresponding threshold value stored in the configuration file 300. In our embodiment where 255 represents all white pixels, if the calculated value is less than the threshold value, e.g., less than 245, then the corresponding field is considered to be filled out completely. Otherwise, the corresponding fields are considered incomplete. For example, if the calculated pixel intensity of the field—“Name” is 240 and the threshold value as set is “248”, this indicates that the content against the field “Name” is filled out completely. After performing the completeness check, one or more rules are applied to determine the correctness of the filled out content. One such rule may be that the married and unmarried fields cannot both be filled out. In another example, the rule may be that the male and female fields cannot both be chosen. If such mutually exclusive fields are found to both be filled out, then the automation system 102 indicates that the fields are wrongly filled out. After performing comparison and applying rules, one or more messages are displayed to the customer at 410. In case of any errors, the system 102 displays error messages to the customer for any necessary actions. In cases where the customer fills out the mutually exclusive fields, the system 102 displays a robust error and in such situations the customer has to fill out a new application form and the entire process discussed above will be repeated until the form is filled out appropriately. Otherwise, the system 102 displays a message indicating the form is filled out successfully. The system 102 maintains a log of error messages and the corresponding actions taken by the customer. In another embodiment, the customer may have the option of correcting the error on the system. In other words, after the error messages are displayed to the customer, the system 102 still allows the customer to perform one or more actions based on the messages, at 412. Here, the actions can be filling out one or more missing fields or correcting the wrongly filled entries against the corresponding fields. In particular, the system 102 allows the customer to interact and corrects the forms. In scenario 1, where the customer makes the changes on the physical hard copy of the form and then the customer re-submits the form for scanning, accordingly, the system 102 may be configured to only scans for the corrected entries and proceed further. In the second scenario, the customer can make the changes in the form through the system 102 itself This means that the required fields can be corrected by the customer online on the system 102. Here, the form is printed with the previous content and the corrected content on top of it and puts signatures. Thereafter, the form is submitted for scanning and the entire process is repeated until the application form is filled out correctly.

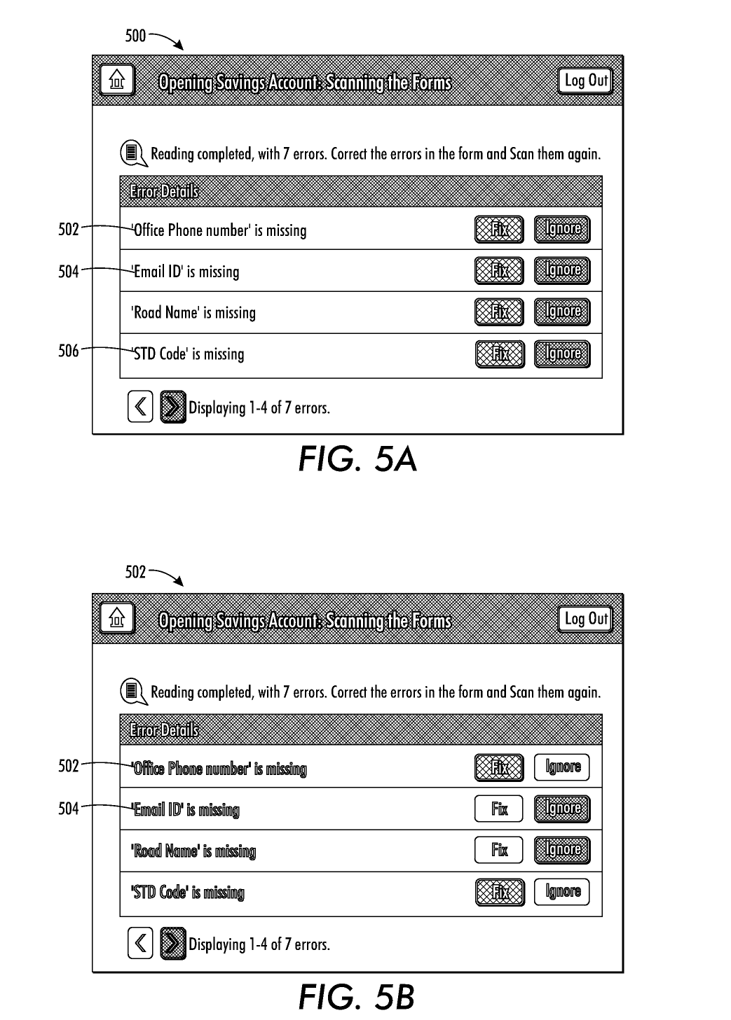

An exemplary dialog box 500 prompting error messages is shown in FIG. 5A. According to FIG. 5A, the content for fields, such as, “office phone number”, depicted by reference numeral 502, is missing. Other missing fields may include “email id” or “STD code”, shown as, 504 or 506, respectively. The displayed errors may be corrected or ignored by the customer. For example, if the field “telephone number” is not mandatory and found missing, then the customer can select the ignore button and ignore the error. However, if the field “STD code” is indicated as having an error and the customer chooses to fix it, he is required to make the corresponding correction on the hard copy document. Once the customer has made his selection on an error message, the messages changes to low light text to indicate to the customer that he has dealt with the item as shown in FIG. 5B. In the illustrated example, the customer corrects the “Office phone number” field and the “STD code” field, as shown in the screen shot of FIG. 5B. Once the corrections have been made on the paper hard copy of the form, the customer submits the form again for scanning In another example, the customer indicates that his name is OM, and the automation system 102 indicates that the “Name” field seems incomplete, but this is the full name of the customer. Therefore, in such cases, the customer can choose to ignore that error.

Based on the error messages, the customer may correct the entries through the system 102 itself. Alternatively, the customer may correct the paper copy or fill out the form again and go through the scanning step one more time. If the customer simply corrects the fields that have been identified by him as being fixed, the system 102 only checks for the corrected entries before extracting the content.

Additionally, the system 102 maintains a log of actions taken by the customer. The log file contains the details of the fields that the customer has fixed/ignored pursuant to the error notification associated with the form scanning process. The log file also contains the error messages. The information in the log file helps in making the verification process at the back-office more efficient.

Once the application form is in order, the system 102 sends the filled out content along with the log file over a network 104 to the back-end office. In some embodiments, information can be compressed before sending it over the network 104. A number of compression algorithms as known in the art can be applied.

For better understanding, an exemplary scenario can be considered, where the customer fills out an application form corresponding to a Savings Account. The application form includes fields—Name, Age, Mobile, City, and Pin Code. The customer then scans the form through the automation system 102. The automation system 102 first extracts the filled out content against each field. Then, the automation system 102 utilizes the configuration file 300 and identifies entries corresponding to fields not filled out correctly, for example, Pin Code. Accordingly, an error message is displayed to the customer. The customer then corrects the Pin code and submits the form again for scanning This time, the system 102 scans the corrected form and extract only the corrected entries or may extract all the entries again. The system here again checks for form completeness or correctness but only for the corrected entries and this time the system does not display errors that were earlier ignored by the customer. If correct, the system 102 updates the corrected entry in the earlier extracted content or information. Finally, the system 102 sends the extracted filled out content along with a log file to the back-office via the network 104.

Back-offices typically include servers, databases, and systems for processing the application forms. Different back-offices may include, a central, record-keeping office, processing centers for executing transactions, a third party validation system, or the like. The back-office may have one or more servers and database. In the back-office, activities including verifying information or data entry are performed. As part of checking the forms again, the log file can be referred to for various purposes.

### Exemplary System

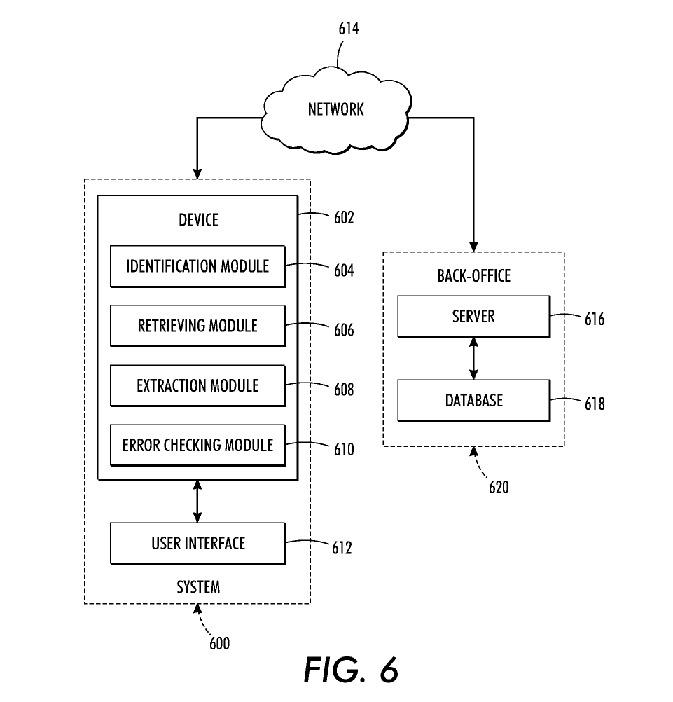

FIG. 6 discloses a system 600 for checking completeness or correctness of application forms. FIG. 6 is shown to include a device 602, network 614, and a back-office 620. The device 602 includes an identification module 604, retrieving module 606, extraction module 608, and error checking module 610. In an embodiment, the device 602 represents a multi-function device or scanner device and accordingly, these modules may form a part of the multi-function device. Alternatively, the device 602 can be replaced by any device or system capable of checking completeness or correctness of application forms. Additionally, the system 600 includes a user interface, 412 facilitating interaction between the customer and the device 602. In certain scenarios, the user interface 612 may be a part of the device 602 or may be external to the device 602.

The user interface 612 allows the customer to log in and displays one or more options relating to application forms for various business services. In the case of banking, application forms are displayed, for example, opening a new account, or applying for loans. In telecom scenarios, forms such as buying a new connection and so forth, are displayed. Based on the preferences and requirements, the customer chooses and fills out a form. Here, the customer prints the form through the device 602 and then fills out the form by hand. Once the application form is successfully filled out, the customer places the application form on the device 602 for scanning To this end, the device 602 includes a platen (not shown) for placing application forms or supporting documents for scanning The device 602 here is capable of performing functionalities including printing, copying along with scanning In some embodiments, the device 602 may be replaced by different units, such as printer, scanner, copier, or the like.

After the form is filled out, the device 602 is used to scan the filled out application forms. While scanning, the identification module 604 identifies the application form type. After identifying, the retrieving module 606 retrieves the corresponding configuration file that includes threshold values and rules. Then, the extraction module 608 separates the background from the filled out content and extracts only the filled out content from each field. This is achieved by comparing the original application form with the filled out application form.

Thereafter, the error checking module 610 calculates the average intensity of content filled out for each field and compares it with the corresponding threshold values stored in the configuration file. In the embodiment where a value of 255 depicts a blank or all white field, while zero depicts an all black field, if the calculated value falls below the threshold value, then the error checking module 610 considers the filled out content as complete. Otherwise, the error checking module 610 considers the filled out content as incomplete. Further, to determine the correctness, the error checking module 610 applies one or more rules to the filled out content. For example, the error checking module 610 applies a rule to determine whether the checkboxes for “married” and “unmarried” are both filled out. If both of the checkboxes are filled out, this means that the content is filled out incorrectly. In such scenarios, the system device displays a robust error, which means that the customer has to fill out a new application form and repeat the entire process as above. In another example, a rule may include: “If there are more than one applicant, then there must be more than one full name”. Finally, when the error checking module 610 completes processing the form, error messages are displayed to the customer through the user interface 612.

The customer determines which errors should be fixed or ignored. Based on the error messages, the device 602 allows the customer to correct the application form. For instance, if the device 602 prompts the customer that the field “Date of Birth” is missing, the customer has two options: the customer can fill out the field on the physical hard copy and re-submit the form for scanning and all the process steps discussed above will be repeated. In the second scenario, the customer can fill out the forms on the device 602 itself, and the new content may be placed on top of the previous content and thereafter, the customer prints the form and then submits it for scanning This process is repeated until the application form meets the criteria defined in the configuration file. Once the device 602 finishes the form checking, the corrected filled out content from each field along with a log file is sent over a network 614 to back-office 620. The log file is sent to the back-office for ensuring correctness of the form, when required. To facilitate interaction between the system 602 and the back-office, a network module (although not shown) is included in the automation system 602.

At the back-office, the extracted content and the log file are received by the server 616 and stored in the database 618. The database 618 in this embodiment stores all types of application forms associated with each service. Each application form is associated with form type, form id or any other information that helps in identifying the forms. Additionally, the back-end server 616 stores the received information for later retrieval or regulatory mandates. In one example, the received filled out content may be used for form re-construction at the server site. Moreover, the log file is utilized for again verifying the forms at the back-end, data entry operations, third party validations or the like.

The present disclosure discloses methods and systems for automatically checking completeness or correctness of application forms. The method reduces the manual effort required for checking the forms at the customer end and thus, reduces the overall processing time. The system provided by the disclosure helps the customer identify errors and allows correcting those at the same time. More specifically, the automation system communicates with the customer about the fields that are not filled out correctly or completely. Further, the system gives control to the customer by actions: fix or ignore. Moreover, the system maintains a log file that contains actions taken by the customer as well as error messages; this accelerates completeness validation at the back-end.

What is claimed is:

1. A system for automatically checking completeness and correctness of a filled out application form, the system comprising:
a device configured to:
receive a filled out application form for scanning;
identify a type of the application form corresponding to the scanned form, the application form including various fields;
retrieve a configuration file corresponding to the form type, the configuration file including one or more threshold values and rules;
extract content filled into the fields in the application form; and
utilize the configuration file to determine at least one of the completeness and correctness of the application form; and
a user interface configured to:
display one or more messages to a customer, based on the threshold values and rules in the configuration file; and
allow the customer to perform one or more actions based on the one or more messages.

2. The system of claim 1 further comprising a database for storing at least one of the configuration file, one or more messages, and extracted content.

3. The system of claim 1, wherein the configuration file includes one or more attributes corresponding to each field in the application form.

4. The system of claim 1, wherein the device is further configured to remove background from the filled out application form.

5. The system of claim 1, wherein the one or more messages are error messages.

6. The system of claim 1 further comprising a network interface configured to connect the device to a network.

7. The system of claim 6, wherein the network interface is configured to send at least one of, the extracted content, the one or more messages, and the actions over the network.

8. A system for automatically checking completeness or correctness of a filled out application form, comprising:
a scanner device configured to receive a filled out application form for scanning, the application form including various fields;
a network interface configured to connect the scanner device to a network;
a server configured to communicate with the scanner device to perform the following:
receive the scanned copy of the filled out application form;
identify a type of the application form;
retrieve a configuration file corresponding to the form type, the configuration file including one or more threshold values and rules;
extract content filled into the fields in the application form; and
utilize the configuration file to determine at least one of the completeness and correctness of the application form; and
a user interface configured to:
display one or more messages to a customer based on the threshold values and rules in the configuration file; and
allow the customer to correct the filled out application form based on the one or more messages.

9. The system of claim 8, wherein the server is further configured to remove background from the filled out application form.

10. A system configured to check completeness or correctness of filled out application forms, the system comprising:
a device that includes:
a scanner configured to scan a filled out application form;
an application running on the device and further configured to:
identify a form type of the filled out application form, the application form including various fields;
retrieve a configuration file corresponding to the form type, the configuration file including one or more threshold values and rules;
extract content filled into the fields in the application form; and
utilize the configuration file to determine at least one of the completeness and correctness of the application form; and
a user interface in communication with the application and further configured to:
display one or more messages to a customer, based on the threshold values and rules in the configuration file; and
allow the customer to perform one or more actions based on the one or more messages.

11. The system of claim 10 further comprising a database for storing the configuration file, the messages, the actions, or the extracted content.

12. The system of claim 10 further comprising a network interface for connecting the device to a network.

13. The system of claim 12, wherein the network interface is configured to send at least one of, the extracted content, the one or more messages, and the actions over the network.

14. A method for automatically checking completeness and correctness of filled out application forms, the method comprising:
providing a device configured to:
identify a type of application form filled out by a customer, the application form including various fields;
retrieve a configuration file corresponding to the type of application form, the configuration file being associated with one or more threshold values and rules;
extract content filled into the fields in the application form; and
utilize the configuration file to determine at least one of the completeness and correctness of the filled out application form; and
interfacing with the customer to perform one or more functions including
displaying one or more messages to the customer based on the threshold values and rules in the configuration file; and
allowing the customer to perform one or more actions based on the displayed messages.

15. A method for automatically checking completeness and correctness of filled out application forms, the method comprising:
providing a device configured to:
identify a type of application form filled out by a customer, the application form including various fields;
retrieve a configuration file corresponding to the form type, the configuration file including one or more threshold values and rules;
extract content filled into the fields in the application form;
calculate an average intensity of pixels of each field;
for each field, comparing the calculated intensity with a corresponding threshold value in the configuration file to determine completeness of the application form; and
apply one or more rules to determine at least one of the completeness and correctness of the filled out application form; and
interfacing with the customer to perform one or more functions including:
displaying one or more messages to the customer, based on the comparison and the rules applied; and
enabling the customer to perform one or more actions based on the displayed messages.

16. The method of claim 15, wherein extraction includes removing background from the filled out application form.

17. The method of claim 15 further comprising defining the configuration file in a pre-defined format.

18. The method of claim 17, wherein the pre-defined format is EXtensible Markup Language (XML).

19. The method of claim 17, wherein the configuration file includes one or more attributes corresponding to each field in the application form.

20. The method of claim 15, wherein the configuration file varies with the type of application form.

21. The method of claim 15 further comprising retaining a copy of at least one of, the configuration file, the extracted content, the messages and the actions.

22. The method of claim 15, wherein the one or more messages are error messages.

23. The method of claim 15 further comprising sending at least one of, the messages, the extracted content, and the actions over a network.
